(19) United States
(12) Patent Application Publication
(10) Pub. No.: US 2018/0016659 A1
(43) Pub. Date: Jan. 18, 2018

(54) METHOD AND DEVICE FOR PROCESSING FLUE DUST

(71) Applicant: AURUBIS AG, Hamburg (DE)

(72) Inventors: Andreas SPECHT, Rosengarten (DE); Harald KADEREIT, Buxtehude (DE); Jürgen SCHMIDL, Hamburg (DE); Michael HOPPE, Aachen (DE)

(21) Appl. No.: 15/714,476

(22) Filed: Sep. 25, 2017

Related U.S. Application Data
(62) Division of application No. 13/583,832, filed on Oct. 23, 2012.

(30) Foreign Application Priority Data
Mar. 10, 2010 (DE) 10 2010 011 242.9

(51) Int. Cl. C22B 7/02; C22B 30/04; F27D 17/00

(52) U.S. Cl. CPC C22B 7/02; F27D 17/008; C22B 30/04; Y02P 10/212

(57) ABSTRACT

The method and the device serve to treat the flue dust formed during the production of nonferrous metals. After the addition of sulfur and/or a sulfur compound, the flue dust is heated, and volatile compounds are separated in a downstream offgas treatment unit. The flue dust is heated in an inert atmosphere.

### CROSS-REFERENCE TO RELATED APPLICATIONS

The present application is a Divisional application of U.S. patent application Ser. No. 13/583,832, filed Oct. 23, 2012, which is a 371 of International application PCT/DE2011/000164, filed Feb. 18, 2011, which claims priority of DE 10 2010 011 242.9, filed Mar. 10, 2010, the priority of these applications is hereby claimed and these applications are incorporated herein by reference.

### BACKGROUND OF THE INVENTION

The invention pertains to a method for treating the flue dust formed during the production of nonferrous metals such as copper and nickel from sulfide-containing ores, in which method the flue dust is heated after the addition of sulfur and/or a sulfur compound, and volatile components are separated. The patent presented here describes the invention on the basis of the production of copper as an example.

The invention also pertains to a device for treating the flue dust formed during the production of nonferrous metals, which device comprises a mixer for supplying and distributing sulfur and/or a sulfur compound and also a unit for thermally treating the mixture produced by the mixer, and which is also equipped with a separator for volatile components.

The previously mentioned mixer can be a component which forms part of the heating unit, or it can be built as a separate device.

In the smelting of copper ores, concentrates in the form of sulfide-containing flotation products are typically used as starting material. About one third of these flotation products consists of copper, another third consists of iron, and the last third consists of sulfur. Small concentrations of many other chemical elements are also present such as arsenic, bismuth, cadmium, and lead. Under the prevailing processing conditions, these secondary elements are distributed among the rock, slag, and offgas phases according to their chemical equilibria. The offgas phase contains both gas and flue dust.

In a first step of processing, some of the iron is removed from the copper concentrate by selective oxidation. By the addition of sand, the oxidized iron is bound in a liquid slag phase at a temperature of approximately 1,200° C. Because of this high temperature, some of the volatile chemical compounds are discharged along with the offgas. To protect the environment and to recover energy, the offgas is treated in a waste-heat boiler and an electric gas purifier. The particles formed by recondensation and the entrained particles constitute the so-called flue dust. The volatile elements are present in this dust in a higher concentration than in the starting product of the concentrate mixture.

Because flue dust contains considerable amounts of copper, efforts are being made to return the flue dust to the smelting process. Because this also means that the volatile elements will also be returned, the concentrations of the secondary elements in the process will increase unless suitable countermeasures are taken.

U.S. Pat. No. 5,234,669 already describes a method for processing flue dust. According to the method described in this publication, however, it is not possible to prevent the accumulation of undesirable chemical elements in the process.

### SUMMARY OF THE INVENTION

The goal of the present invention is therefore to improve a method of the type described above in such a way that the amounts of undesirable volatile compounds in flue dust are reduced more effectively.

This goal is achieved according to the invention in that sulfur or sulfur-containing compounds (e.g., copper concentrate) are added to the flue dust, and in that the heating step is carried out in an inert atmosphere.

An additional goal of the present invention is to design a device of the type indicated above in such a way that the amounts of volatile components in flue dust are reduced more effectively.

This goal is achieved according to the invention in that the unit for thermal treatment is connected to a supply unit for providing an inert atmosphere.

By the use of the inventive method and the corresponding device, it is possible to remove undesirable chemical elements from the flue dust or at least to significantly reduce the amounts present. According to the invention, the formation of SO2-containing offgases is avoided or at least significantly reduced. The offgases therefore do not have to be treated separately like the high SO2-containing offgas of the smelting works in order, for example, to liquefy the SO2 or to convert it to sulfuric acid.

According to the invention, the amounts of offgas produced are smaller than those of conventional methods and devices. Through the use of the inert atmosphere, the sulfur does not occur in the form of SO2 but rather in elementary form or in the form of sulfide compounds. Eliminating the need for an offgas treatment in the form of, for example, a double contact catalyst system for recovering sulfuric acid results in a significant decrease in the necessary investment costs. Additional advantages can be seen in an increase in the throughput of the copper production process and in the support of the possibility of using more complex ore concentrates, because, through the inventive treatment of the flue dust, the enrichment in the process is prevented or significantly reduced.

The present invention offers the possibility of separating and enriching in solid form various elements which negatively affect the quality of the products associated with copper production.

The course of a typical process begins with the discharge of arsenic or an arsenic-sulfur compound as a volatile component with the offgas and ends with its separation as a solid in the downstream offgas purification unit or in the wash water.

Conducting the treatment of the flue dust as a continuous process represents a simple way of conducting the method.

According to another variant of the process, however, it is also possible to conduct the treatment of the flue dust as a discontinuous process.

According to a simple version of the process, the flue dust can be treated at ambient pressure.

The removal of the volatile components can be facilitated by treating the flue dust at a negative pressure, such as at a pressure of 200-400 mbars.

The thermal processes which occur during the treatment of the flue dust during the thermal treatment step can be accelerated by treating the flue dust at a positive pressure.

In a typical process, the temperature during the heating of the flue dust will be at least temporarily in the range of 500-1,000° C. A range of 650-950° C. is preferred.

According to a preferred embodiment, the attempt is made to ensure an average content of sulfur dioxide in the offgas of no more than 5 vol. %. The average content is preferably no more than 2 vol. %.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawings:

FIG. 1 shows the concept of a system for the pyrometallurgical treatment of flue dust in a rotary kiln with a two-stage offgas treatment;

FIG. 2 shows the concept of a method for the pyrometallurgical treatment of flue dust in the fluidized-bed process with a one-stage offgas treatment;

FIG. 3 shows a diagram of the removal of flue dust; and

FIG. 4 shows a sulfur balance for comparison of the prior art with the inventive method.

### DETAILED DESCRIPTION OF THE INVENTION

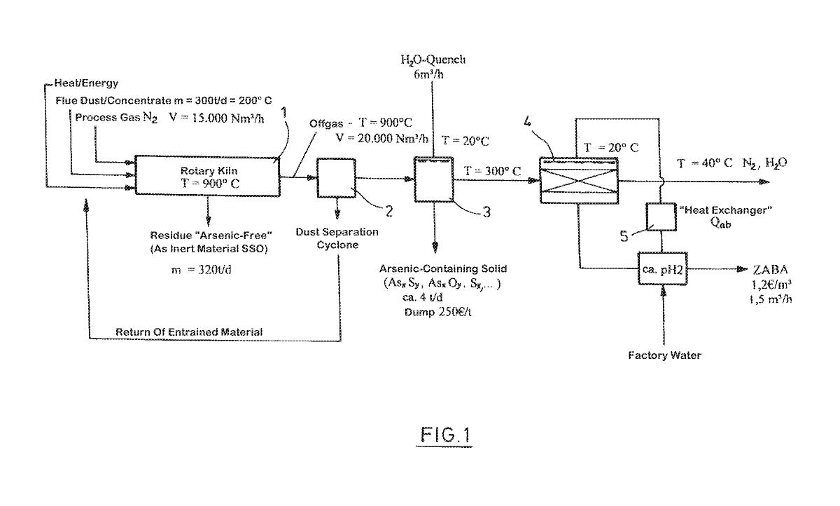

FIG. 1 shows the use of a rotary kiln 1, in which the supplied material is treated at a temperature of approximately 900° C. The supplied materials consist in this case of a copper concentrate and separated flue dust. The dust is separated in the area of a cyclone 2.

The treatment in the rotary kiln 1 proceeds in an inert atmosphere. Typically, nitrogen is used for this. When the mixture of concentrate and flue dust is supplied at a mass flow rate of 300 tons per day, nitrogen will typically be supplied at a rate of 15,000 Nm3 per hour. At this level of throughput, the amount of offgas supplied to the cyclone 2 will typically be 20,000 Nm3 per hour at an offgas temperature of approximately 900° C. (Nm3=normal cubic meter).

Other gases can be used as an alternative to nitrogen as the inert gas. For example, the use of argon is possible. The grate temperature of 900° C. represents merely a preferred temperature. It is typically possible to realize a temperature in the range from 650° C. to 950° C. The flue dust and the fresh concentrate are supplied to the rotary kiln 1 in a concentrate-to-flue dust mixing ratio typically in the range of 1:3-1:1. The residence time of the mixture in the rotary kiln 1 is typically 1-4 hours.

Downstream from the cyclone 2, a separator 3 is installed, in which an arsenic-containing solid is collected. Offgas from the separator 3 is sent to a secondary separator 4. For energy recovery, the secondary separator 4 is provided with a heat exchanger 5 to reduce the temperature of the final offgas to about 40° C. and to make use of the available energy.

All of the values for the process parameters in FIG. 1 are given merely as examples and can be varied over a considerable range. The method can thus be adapted to the concrete requirements of the application, to the throughputs, and to the nature of the starting products.

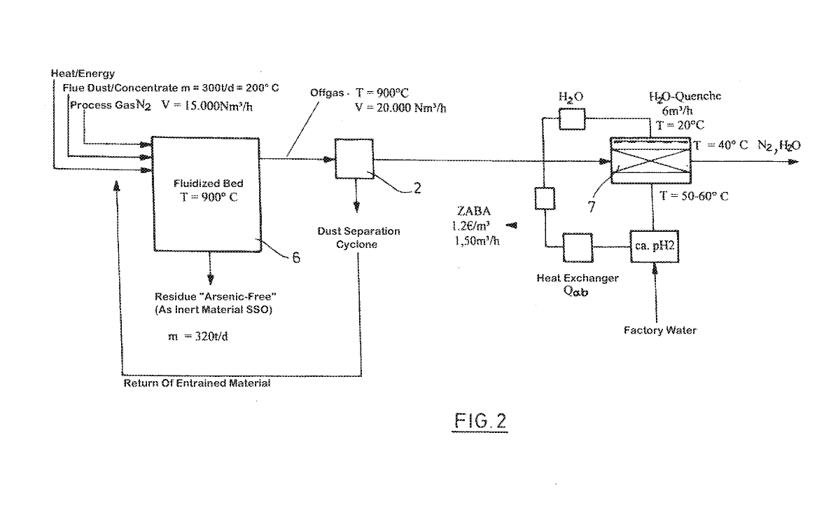

FIG. 2 shows a modification of the concept according to FIG. 1. Instead of the rotary kiln 1, a fluidized-bed system 6 is used. The separator 3 and the secondary separator 4 are combined into a one-stage separator 7. By the use of the heat exchanger 5, the temperature of the final offgas can be suitably reduced with this concept as well.

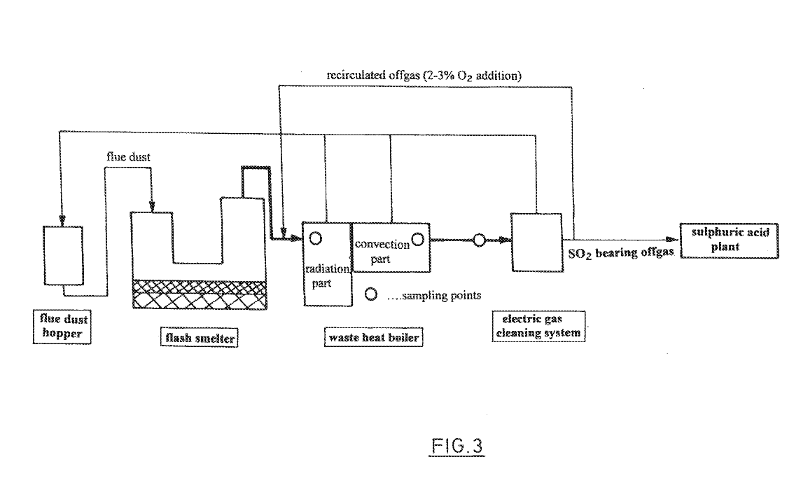

FIG. 3 illustrates in general terms how the flue dust is handled and discharged during copper production.

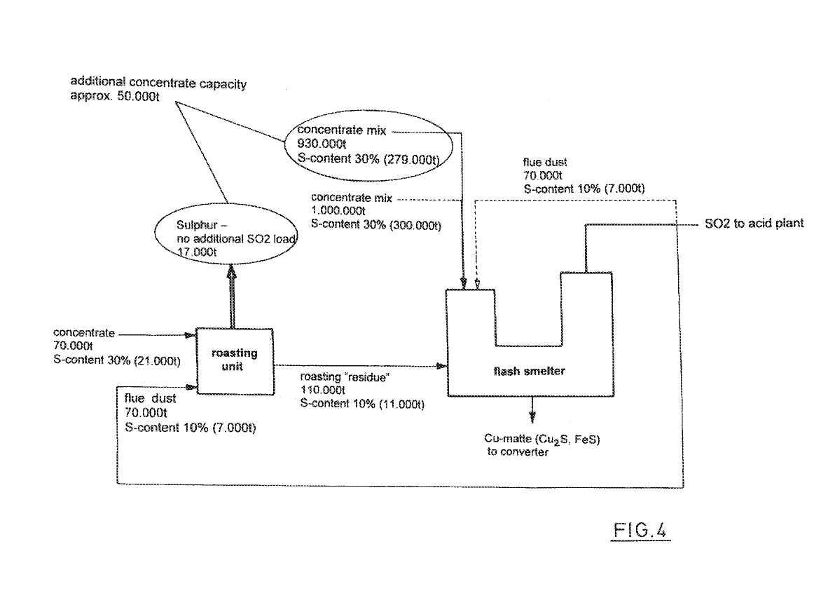

FIG. 4 illustrates a sulfur balance for comparison of the prior art with the inventive concept of the method for a selected throughput example.

The inventive separation and treatment of the flue dust is preferably conducted as a continuous process. Also preferred is a process conducted at ambient pressure. The process can also be conducted, however, at a negative pressure or at a positive pressure, depending on the concrete requirements of the application.

The inventive treatment of the flue dust in an inert atmosphere takes especially into account the fact that arsenic or other substances to be removed from the flue dust are typically in a form different from that of the underlying concentrate. Comparison shows that the distribution coefficients and other chemical bonds in the flue dust are typically different from those in the concentrate. For example, the arsenic in the concentrate can be in the form of enargite, tennantite, arsenopyrite, or arsenic sulfide; whereas, in the flue dust, the arsenic is typically in the form of arsenic oxide, arsenic sulfide, and iron or copper arsenate.

The inert atmosphere during the roasting process makes it possible to achieve a significant lowering of the SO2 content in the offgas. What is aimed for here is an SO2 content below 5 vol. %, preferably below 2 vol. %. As an option, it is also possible to oxidize the offgas or certain portions of the offgas.

While specific embodiments of the invention have been shown and described in detail to illustrate the inventive principles, it will be understood that the invention may be embodied otherwise without departing from such principles.

We claim:

1. A method for processing flue dust formed during production of copper based on a smelting process of copper ores, the method comprising the steps of: adding sulfur and/or a sulfur compound to the flue dust; heating the flue dust in an inert atmosphere after the addition of the sulfur and/or sulfur compound; and separating volatile components, the flue dust being subjected to a pyrometallurgical treatment in a fluidized bed reactor in which the flue dust is heated in an inert atmosphere, the pyrometallurgical treatment producing an offgas that is subjected to an offgas treatment for removing arsenic-sulfur compounds as volatile elements, wherein treatment of the flue gas is carried out as a continuous process.

2. The method according to claim 1, including volatilizing arsenic in elementary form or in form of arsenic-sulfur compounds and then separating the arsenic or arsenic-sulfur compound from the flue dust.

3. The method according to claim 1, including processing the flue dust at ambient pressure.

4. The method according to claim 1, including carrying out the treatment of the flue dust at a negative pressure.

5. The method according to claim 1, including carrying out the treatment of the flue at a positive pressure.

6. The method according to claim 1, wherein an average amount of sulfur dioxide in the offgas is no greater than 5 vol. %.

7. The method according to claim 1, wherein the heating of the flue dust includes heating the flue dust at least temporarily to a temperature in the range of 500-1,000° C.
